(19) United States
(12) Patent Application Publication
(10) Pub. No.: US 2026/0030284 A1
(43) Pub. Date: Jan. 29, 2026

(54) DEEP-LEARNING-BASED DOCUMENT CLASSIFICATION DEVICE AND METHOD FOR PERFORMING IT

(71) Applicant: CHUNG ANG UNIVERSITY INDUSTRY ACADEMIC COOPERATION FOUNDATION, Seoul (KR)

(72) Inventors: YOUNG BIN KIM, Seoul (KR); JUNG MIN YUN, Daejeon (KR)

(21) Appl. No.: 19/279,002

(22) Filed: Jul. 24, 2025

(30) Foreign Application Priority Data
Jul. 24, 2024 (KR) 10-2024-0098119

(51) Int. Cl. G06F 16/35; G06F 40/284

(52) U.S. Cl. CPC G06F 16/35; G06F 40/284

(57) ABSTRACT

A document classification method is performed in a computing device equipped with one or more processors and a memory storing one or more programs executed by the one or more processors. The document classification method includes acquiring sequence data obtained by digitizing a document, and embedding the acquired sequence data to produce embedded data including one or more tokens, generating fuzzy-pruned data pruned by performing token pruning the embedded data, which is a set of tokens, based on fuzzy theory, producing combined tokens by combining tokens of the pruned fuzzy-pruned data with seed tokens of seed data, and generating combined data as a set of the combined tokens, and producing one classification value based on the combined data.

### CROSS-REFERENCE TO RELATED APPLICATION AND CLAIM OF PRIORITY

This application claims the benefit under 35 USC § 119 of Korean Patent Application No. 10-2024-0098119, filed on Jul. 24, 2024, in the Korean Intellectual Property Office, the entire disclosure of which is incorporated herein by reference for all purposes.

### BACKGROUND

### 1. Technical Field

The examples of the present invention are related to a deep-learning-based document classification device and a document classification method technology for performing it.

### 2. Background Art

In the field of program technology, lightweighting of models that constitute a program is important in aspects, including improvement of program performance, reduction in resources such as memory, storage space, power, and the like consumed by the program, ease of portability to diverse platforms and devices, enhancement of security by reducing the attack surface, and the like.

Recently, data classification technology using artificial intelligence, has been applying token pruning, which removes tokens with low information and redundancy, for lightweighting of models. However, in models to which a conventional token pruning method is applied, the accuracy of the models is reduced due to the following reasons.

First, since pruning is performed on the entire sequence, which is an input value, information loss occurs. Second, as pruning is performed based on token frequency, the importance of individual tokens is not considered.

Accordingly, there is a need for technologies of a deep-learning-based document classification device which is lightened while maintaining accuracy of document classification, and a document classification method for performing the same.

### SUMMARY

The examples of the present invention are to provide a deep-learning-based document classification device which is lightened while maintaining accuracy of document classification, and a document classification method for performing the same.

The document classification method according to one example disclosed is a method performed in a computing device equipped with one or more processors, and a memory storing one or more programs executed by the one or more processors, and includes acquiring sequence data obtained by digitizing a document, and embedding the acquired sequence data to produce embedded data including one or more tokens, generating fuzzy-pruned data pruned by performing token pruning the embedded data, which is a set of tokens, based on fuzzy theory, producing combined tokens by combining tokens of the pruned fuzzy-pruned data with seed tokens of seed data, and generating combined data as a set of the combined tokens, and producing one classification value based on the combined data.

The generating fuzzy-pruned data, may include calculating a token importance score being an indicator of a degree of importance for each token included in the embedded data, and performing the pruning based on the token importance score.

The performing the pruning based on the token importance score, may include calculating an importance index and an unimportance index being a criterion of the pruning by applying the fuzzy theory to the token importance score, for each of the tokens of the embedded data; and performing the pruning the tokens of the embedded data according to a predetermined criterion based on the importance index and the unimportance index.

The importance index (Importance(S)) may be calculated by Equation 1 below.

$$Importance ( S ) = \{ \begin{matrix}0 & if S ( e ) \leq a \\ \frac{S ( e ) - a}{b - a} & if a < S ( e ) < b \\ 1 & if S ( e ) \geq b\end{matrix} \qquad ( Equation 1 )$$

Importance(S): Importance index
S(e): Importance score
a: Predetermined lower limit of importance score
b: Predetermined upper limit of importance score

The unimportance index (Unimportance(S)) may be calculated by Equation 2 below.

$$Unimportance ( S ) = \{ \begin{matrix}1 & if S ( e ) \leq a \\ \frac{b - S ( e )}{b - a} & if a < S ( e ) < b \\ 0 & if S ( e ) \geq b\end{matrix} \qquad ( Equation 2 )$$

Unimportance(S): Unimportance index
S(e): Importance score
a: Predetermined lower limit of importance score
b: Predetermined upper limit of importance score

The performing the pruning may include removing the tokens of the embedded data from computation targets of a fuzzy pruning attention neural network.

The removing from computation targets of a fuzzy pruning attention neural network may include removing at least one of a key vector and a value vector of each token of the embedded data.

The generating combined data may include calculating similarity between each token of the fuzzy-pruned data and each seed token, generating seed determination data indicating to which seed token each token of the fuzzy-pruned data is to be combined, according to the similarity, and combining the tokens of the fuzzy-pruned data with the seed tokens of the seed data, based on the seed determination data.

The calculating similarity may include performing cross attention between the fuzzy-pruned data and the seed data which is a set of the seed tokens to which each token of the fuzzy-pruned data is to be combined.

The generating seed determination data may include determining that each token of the fuzzy-pruned data is to be combined with a seed token with the highest similarity among a plurality of the seed tokens.

The document classification device according to one example disclosed is a document classification device equipped with one or more processors, and a memory storing one or more programs executed by the one or more processors, and includes an embedding module which acquires sequence data obtained by digitizing a document, and embeds the acquired sequence data to produce embedded data including one or more tokens, a fuzzy pruning module which generates fuzzy-pruned data pruned by performing token pruning the embedded data, which is a set of tokens, based on fuzzy theory, a combining module which produces combined tokens by combining tokens of the pruned fuzzy-pruned data with seed tokens of seed data, and generates combined data as a set of the combined tokens, and a classification module which produces one classification value based on the combined data.

The computer program according to one example disclosed is a computer program stored in a non-transitory computer readable storage medium, and the computer program includes one or more instructions, and the instructions, when executed by a computing device having one or more processors, makes the computing device, perform acquiring sequence data obtained by digitizing a document, and embedding the acquired sequence data to produce embedded data including one or more tokens, generating fuzzy-pruned data pruned by performing token pruning the embedded data, which is a set of tokens, based on fuzzy theory, producing combined tokens by combining tokens of the pruned fuzzy-pruned data with seed tokens of seed data, and generating combined data as a set of the combined tokens, and producing one classification value based on the combined data.

According to the disclosed examples, a deep-learning-based document classification device which is lightened while maintaining accuracy of document classification, and a document classification method for performing the same can be provided.

### BRIEF DESCRIPTION OF THE DRAWINGS

The present disclosure will be readily understood by the following detailed description in conjunction with the accompanying drawings, and reference numerals refer to structural elements.

FIG. 1 is a flowchart for describing an of a document classification device for performing document classification, according to one example of the present invention.

FIG. 2 is a block diagram schematically showing a configuration of a document classification device for performing document classification, according to one example of the present invention.

FIG. 3 is a block diagram for describing a configuration of a document classification device for performing document classification, according to one example of the present invention.

FIG. 4 is a flowchart for describing generating pruned fuzzy-pruned data by performing token pruning embedded data, which is a set of tokens, based on fuzzy theory by a fuzzy pruning module, according to one example of the present invention.

FIG. 5 is a diagram for describing a fuzzy pruning module which generates fuzzy-pruned data pruned by performing token pruning embedded data, which is a set of tokens, based on fuzzy theory, according to one example of the present invention.

FIG. 6 is a flowchart for describing producing combined tokens by combining tokens of the pruned fuzzy-pruned data with seed tokens of seed data, and generating combined data with the combined tokens as a set by a combining module, according to one example of the present invention.

FIG. 7 is a diagram for describing the combining module, which produces combined tokens by combining tokens of the pruned fuzzy-pruned data with seed tokens of seed data, and generates combined data with the combined tokens as a set, according to one example of the present invention.

FIG. 8 is a block diagram for illustrating and describing a computing environment including a computing device suitable for use in exemplary examples.

### DETAILED DESCRIPTION

Hereinafter, specific embodiments of the present invention will be described with reference to drawings. The following detailed description is provided to help a comprehensive understanding of the method, device, and/or system described in the present description. However, these are only examples, and the present invention is not limited thereto.

In describing the example of the present invention, when it is judged that a detailed description of the prior art related to the present invention may unnecessarily obscure the gist of the present invention, the detailed description will be omitted. In addition, the terms described below are terms defined in consideration of functions in the present invention may vary depending on the intention or practice or the like of the user or operator. Therefore, the definition should be based on the contents throughout the present entire description. The terms used in the detailed description are intended to describe the examples of the present invention only, and should not be limited. Unless used otherwise clearly, singular expressions include meanings of plural expressions. In the present description, expressions such as “comprising” or “equipped” are intended to refer to certain features, numbers, steps, s, elements, parts or combinations thereof, and they should not be construed to exclude the presence or possibility of one or more other features, numbers, steps, s, elements, parts of combinations thereof, other than those described.

In addition, the terms of the first, the second, and the like can be used to describe various components, but the components should not be limited by the terms. The terms may be used for the purpose of distinguish one component from other components. For example, without departing from the scope of the present invention, the first component may be named the second component, and similarly, the second component may also be named the first component.

In the present description, “document classification device (100)” may provide information on type of the document by analyzing an inputted document. The document classification device (100) may provide information on type of the document while reducing an amount and improving accuracy compared to the prior art, by performing token pruning based on fuzzy theory, in analyzing a document.

The document classification device (100) may include one or more processors and a computer readable recording medium connected with the processors, which are required for providing information on type of the document by analyzing a document, and further include a database for storing data. The computer readable recording medium may be located inside or outside of the processor, and may be connected with the processor by various well-known means. The processor in the computing device (100) may make the computing device (100) operate according to the exemplary example described in the present description. For example, the processor may execute instructions stored in the computer readable recording medium, and the instructions stored in the computer readable recording medium may be configured to make the computing device (100) perform s according to the exemplary example described in the present description, when executed by the processor.

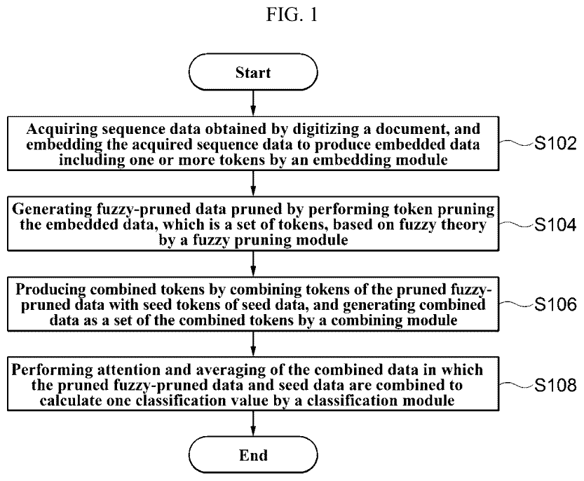

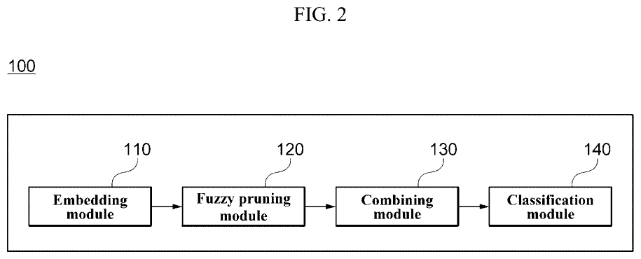

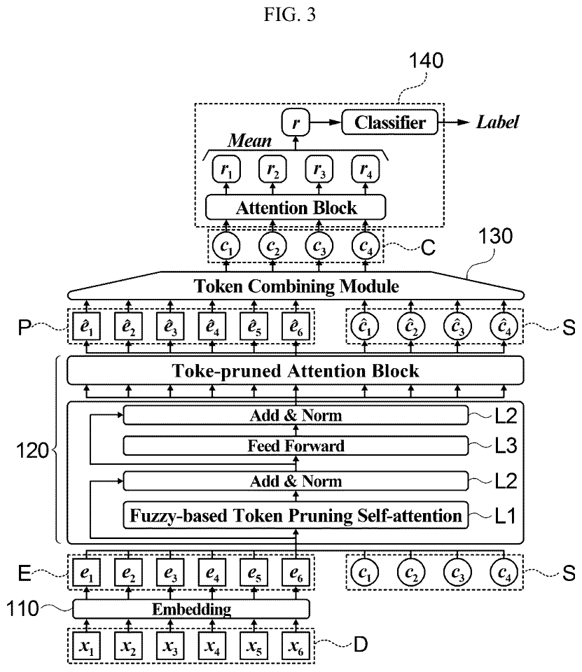

FIG. 1 is a flowchart for describing an of a document classification device for performing document classification, according to one example of the present invention. In the illustrated flowchart, the method is described as divided into a plurality of steps, but at least some of the steps may be performed in a different order, performed together by being combined with other steps, omitted, performed as divided into detailed steps, or performed by adding one or more steps unillustrated. In addition, FIG. 2 is a block diagram schematically showing a configuration of a document classification device for performing document classification, according to one example of the present invention, and FIG. 3 is a block diagram for describing a configuration of a document classification device for performing document classification, according to one example of the present invention.

Referring to FIGS. 1 to 3, in the step S102, the embedding module (110) may generate embedded data (E) including one or more tokens by acquiring sequence data (D) obtained by digitizing a document (one or more sentences) and embedding the obtained sequence data (D).

Specifically, a document may be parsed to be a set of a plurality of word segments, and the set of the plurality of word segments may be digitized to become sequence data (D). The embedding module (110) may generate embedded data (E) as a set of tokens which are vectors in a computing space, by passing the sequence data through an embedding neural network (embedding layer). The embedded data (E) may be an input value of the fuzzy pruning module (120). The embedding module (110) may transmit the embedded data (E) to the fuzzy pruning module (120).

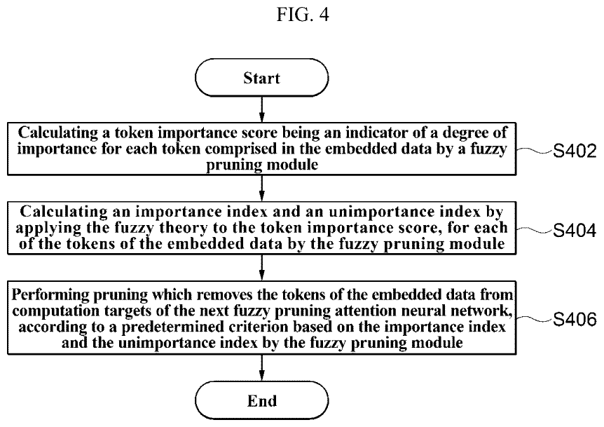

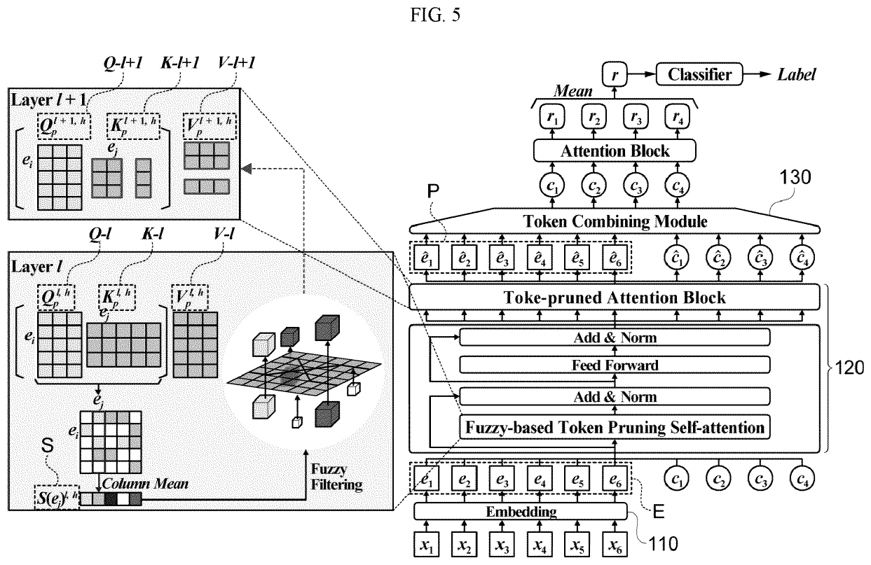

In the step S104, the fuzzy pruning module (120) may generate fuzzy-pruned data (P) pruned by performing token pruning the embedded data (E) which is a set of tokens, based on fuzzy theory. Specifically, the fuzzy pruning module (120) may receive the embedded data (E) which is a set of tokens from the embedding module (110). The fuzzy pruning module (120) may generate fuzzy pruned data (P) pruned one or more times by passing the embedded data (E) through one or more fuzzy pruning attention neural network (L1) which perform token pruning by applying fuzzy theory. Specific description of that the fuzzy pruning module (120) performs pruning tokens of the embedded data (E) through the fuzzy pruning attention neural network (L1) will be described later through FIGS. 4 and 5 below.

In addition, the fuzzy pruning module (120) may acquire seed data (S1) which is a set of seed tokens that are targets to which the tokens of the embedded date (E) are combined and transmit them to the combining module (130).

Specifically, the fuzzy pruning module (120) may acquire seed data (S1) which is a set of seed tokens that are targets to which the tokens of the embedded data (E) are combined, and pass the acquired seed data (S1) though one or more fuzzy pruning attention neural networks (L1), but the seed data (S1) may be excluded from the targets for token pruning. In other words, the seed data (S2) that has passed through the fuzzy pruning attention neural networks (L1) may be identical to the seed data (S1) before passing through the fuzzy pruning attention neural networks (L1). The seed tokens serve as seeds to which the tokens of the embedded data (E) are combined, and may not include information.

On the other hand, the fuzzy pruning module (120) may further include an addition and normalization layer (L2) and a feed forward layer (L3) as sublayers as same as a common attention performing device. This relates to known techniques, and a detailed description will be omitted.

FIG. 4 is a flowchart for describing generating pruned fuzzy-pruned data by performing token pruning embedded data, which is a set of tokens, based on fuzzy theory by a fuzzy pruning module, according to one example of the present invention, and FIG. 5 is a diagram for describing a fuzzy pruning module which generates fuzzy-pruned data pruned by performing token pruning embedded data, which is a set of tokens, based on fuzzy theory, according to one example of the present invention.

Referring to FIGS. 4 and 5, in the step S402, the fuzzy pruning module (120) may calculate a token importance score (S) being an indicator of a degree of importance for each token included in the embedded data (E). Specifically, the token importance score (S) may be calculated based on the number of times the corresponding token is referenced by other tokens. In an exemplary example, that the token importance score (S) is high may mean that a token is referenced many times from other tokens, and a token which is referenced many times from other tokens is an important token.

In the step S404, the fuzzy pruning module (120) may calculate an importance index (I) and an unimportance index (U) by applying the fuzzy theory to the token importance score (S), for each of the tokens of the embedded data. Specifically, a detailed description of applying the fuzzy theory to the token importance score (S) is as follows. In an exemplary example, the fuzzy pruning module (120) may classify the importance score (S) into a preset numerical range, and calculate an importance index (I, Importance) and an unimportance index (U, Unimportance) according to the classified range.

The calculating an importance index (I) according to a preset numerical range may be as the following Equation 1, and the calculating an unimportance index (U) according to a preset numerical range may be as the following Equation 2.

$$Importance ( S ) = \{ \begin{matrix}0 & if S ( e ) \leq a \\ \frac{S ( e ) - a}{b - a} & if a < S ( e ) < b \\ 1 & if S ( e ) \geq b\end{matrix} \qquad Equation 1 )$$

$$Unimportance ( S ) = \{ \begin{matrix}1 & if S ( e ) \leq a \\ \frac{b - S ( e )}{b - a} & if a < S ( e ) < b \\ 0 & if S ( e ) \geq b\end{matrix} \qquad Equation 2 )$$

Referring to Equation 1 and Equation 2, the preset numerical range may be divided into three ranges of a value equal to or lower than the lower limit (a), a value greater than the lower limit (a) and less than the upper limit (b), and a value equal to or greater than the upper limit (b).

On the other hand, the importance index (I) and unimportance index (U) may be a probability that the corresponding token belongs to an important one. The importance index (I) and unimportance index (U) may be a numerical value ranging from 0 to 1, and 0 may indicate that the corresponding token is not important, and 1 may indicate that the corresponding token is important.

When the importance score (S) is equal to or lower than the lower limit (a), the importance index (I) may be 0, and the unimportance index (U) may be 1. In addition, when the importance score (S) is greater than the lower limit value (a) and less than the upper limit value (b), the importance index (I) may be (S−a)/(b−a), and the unimportance index (U) may be (b−S)/(b−a). Furthermore, when the importance score (S) is equal to or greater than the upper limit value (b), the importance index (I) may be 1, and the unimportance index (U) may be 0.

In the step S406, the fuzzy pruning module (120) may perform pruning that removes tokens of the embedded data from computation targets of the next fuzzy pruning attention neural network, according to a predetermined pruning criterion based on the importance index (I) and the unimportance index (U). In an exemplary example, the predetermined pruning criterion may be that a value obtained by subtracting the unimportance index (U) from the importance index (I) is not included in the predetermined numerical range. For example, when a value obtained by subtracting the unimportance index (U) from the importance index (I) is equal to or less than the predetermined value, the corresponding token may be determined to be unimportant, and the corresponding token may be pruned.

In an exemplary example, the fuzzy pruning attention neural network may be a neural network performing self-attention. The self-attention, may be attention that calculates the degree of influence of each of tokens on other tokens. Then, a token that serves as the center of attention may be represented as a query vector, and each other token excluding the query vector may be represented as a key vector, and the degree to which the query vector is referenced from the key vectors may be represented as a value vector of the corresponding token.

The present invention may not remove the token itself, but remove only the key vector and value vector of the corresponding token. In other words, in the present invention, the corresponding token is removed from operation targets, may not use the corresponding token as a key vector of another token in performing self-attention. By reducing the targets of operation, it is possible to implement a computing task that is faster and consumes fewer resources.

When described by referring to FIG. 5, the matrix (Q-l) of query vectors of the lth layer may be maintained even after the fuzzy pruning attention neural network (L1). In other words, the matrix (Q-l+1) of query vectors of the l+1th layer may be identical to the matrix (Q-l) of query vectors of the lth layer.

On the other hand, the matrix (K-l) of key vectors of the lth layer may be partially removed after passing through the fuzzy pruning attention neural network (L1). Then, the ratio of removal may follow a preset ratio. In other words, the matrix (K-l+1) of key vectors of the l+1th layer may be one in which one or more of partial rows and columns are removed from the matrix (K-l) of key vectors of the lth layer.

As the matrix of key vectors is partially removed, the matrix of value vectors of the lth layer may be also partially removed after passing through the fuzzy pruning attention neural network (L1). In other words, the matrix (V-l+1) of value vectors of the l+1th layer may be one in which one or more of partial rows and columns are removed from the matrix (V-l) of value vectors of the lth layer.

The fuzzy pruning module (120) may obtain fuzzy pruned data pruned, by passing through the fuzzy pruning neural network, which removes a plurality of tokens of embedded data are removed from operation, one or more times by the same method of the above step S402 and step S406.

Referring to FIGS. 1 to 3 again, in the step S106, the combining module (130) produces combined tokens by combining tokens of pruned fuzzy-pruned data with seed tokens of seed data, and generates combined data with the combined tokens as a set.

Specifically, the combining module (130) may receive the pruned fuzzy-pruned data (P) from the fuzzy pruning module (120). The pruned fuzzy-pruned data (P) may be data in which one or more of the tokens included in the embedded data (E) are pruned as targets of operation and removed. In addition, the combining module (130) may acquire seed data which is a set of seed tokens that serves as seeds to which the tokens of the embedded data are combined. In an exemplary example, the combining module (130) may receive seed data from the fuzzy pruning module (120).

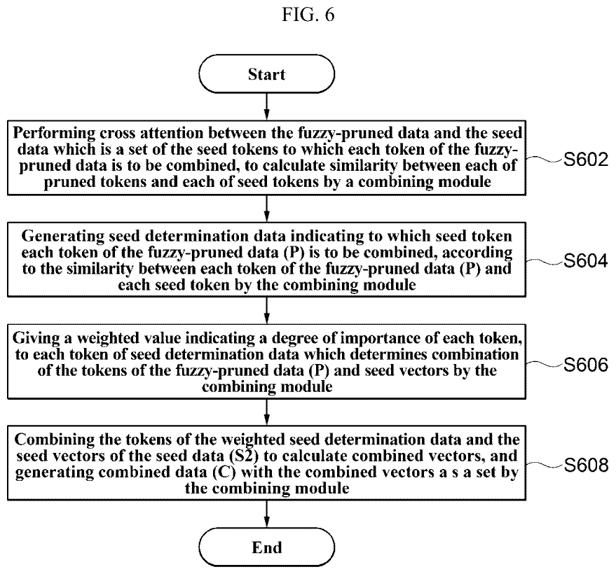

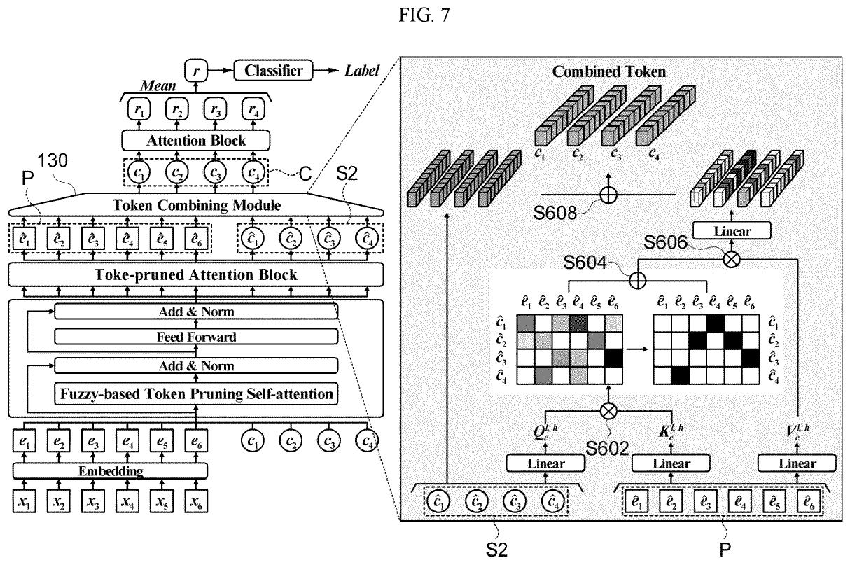

The combining module (130) may generate combined data which is a set of the combined tokens in which the tokens of the fuzzy-pruned data and the seed tokens of the seed data are combined, by passing the pruned fuzzy-pruned data and seed data which is a seed of combination through the combined neural network that performs combination of tokens. A detailed description of that the combining module (130) generates combined data through the combined neural network will be described later through FIGS. 6 and 7 below.

FIG. 6 is a flowchart for describing producing combined tokens by combining tokens of the pruned fuzzy-pruned data with seed tokens of seed data, and generating combined data with the combined tokens as a set by a combining module, according to one example of the present invention, and FIG. 7 is a diagram for describing the combining module, which produces combined tokens by combining tokens of the pruned fuzzy-pruned data with seed tokens of seed data, and generates combined data with the combined tokens as a set, according to one example of the present invention.

Referring to FIGS. 6 and 7, in the step S602, the combining module (130) may calculate similarity between each pruned token and each seed token, by cross attention (internal attention) of fuzzy-pruned data (P) in which the embedded data (E) is pruned and seed data (S2) which is a set of seed vectors to which the tokens of the fuzzy-pruned data (P) are to be combined.

Specifically, the combining module (130) may receive the fuzzy-pruned data (P) in which the embedded data (E) is pruned from the fuzzy pruning module (120), and may acquire the seed data (S2) which is a set of seed tokens to which the tokens of the fuzzy-pruned data (P) are to be combined. Next, the combining module (130) may normalize the acquired fuzzy-pruned data (P) to generate linear fuzzy-pruned data (P), and normalize the acquired seed data (S2) to generate linear seed data (S2). Then, the combining module (130) may perform cross attention of query data of the linear fuzzy-pruned data (P) and key data of the linear seed data (S2), to calculate a matrix that represents the similarity between each pruned token and each seed token.

In the step S604, the combining module (130) may generate seed determination data representing to which seed each token of the fuzzy-pruned data (P) is to be combined, according to the similarity between each token of the fuzzy-pruned data (P) and each seed token.

Specifically, the combining module (130) may determine to combine each pruned token with a seed token with the highest similarity, in the matrix exhibiting the similarity between each pruned token and each seed token. When described by referring to FIG. 7, the combining module (130) may determine to combine each of the tokens of the fuzzy-pruned data (P), with a seed token with the highest similarity (referring to FIG. 7, the darkest one in each row) among a plurality of seed tokens.

In the step S606, the combining module (130) may give a weighted value indicating the degree of importance of each token, to each token of seed determination data which determines combination of the tokens of the fuzzy-pruned data (P) and seed vectors.

Specifically, the combining module (130) may combine value data of the normalized fuzzy-pruned data (P), to seed determination data that determines combination of the tokens of the fuzzy-pruned data (P) and seed vectors. Then, the value data may represent the weighted value of each token of the fuzzy-pruned data (P).

In the step S608, the combining module (130) may combine the tokens of the weighted seed determination data and the seed vectors of the seed data (S2) to calculate combined vectors, and generate combined data (C) with the combined vectors as a set.

Specifically, the combining module (130) may calculate combined vectors by combining the tokens of seed determination data and the seed vectors of seed data (S2), based on information of combination of the tokens of the fuzzy-pruned data (P) and the seed vectors, which is determined from the seed determination data.

Next, the combining module (130) may transmit the combined data (C) in which the pruned fuzzy-pruned data and seed data are combined into the classification module (140).

Referring to FIGS. 1 to 3 again, in the step S108, the classification module (140) may calculate one classification value by performing attention and averaging combined data in which the pruned fuzzy-pruned data and seed data are combined. Specifically, the classification module (140) may calculate one value by performing attention by passing the combined data through a neural network that performs self-attention, and averaging values of the attention results. The calculated one value may refer to one of the predetermined document types.

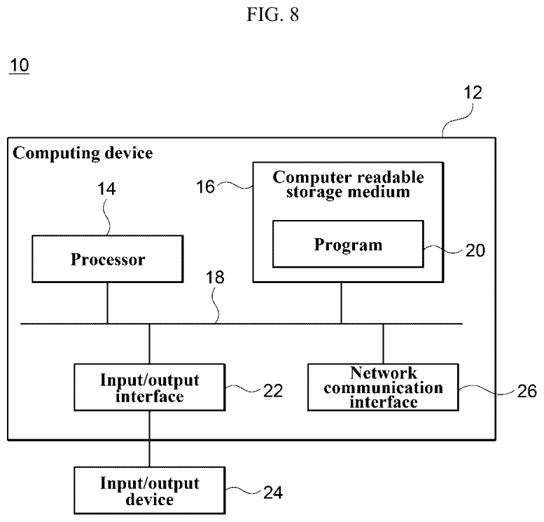

FIG. 8 is a block diagram for illustrating and describing a computing environment (10) including a computing device suitable for use in exemplary examples. In the illustrated example, each component may have different functions and ability other than those described below, and may include an additional component other than those described below.

The illustrated computing environment (10) includes a computing device (12). In one example, the computing device (12) may be the document classification device (100).

The computing device (12) includes at least one processor (14), a computer readable storage medium (16) and a communication bus (18). The processor (14) may allow the computing device (12) to operate according to the exemplary example mentioned above. For example, the processor (14) may execute at least one program stored in the computer readable storage medium (16). The at least one program may include at least one computer executable instruction, and the computer executable instruction may be composed to allow the computing device (12) to perform s according to the exemplary example, when executed by the processor (14).

The computer readable storage medium (16) is composed to store computer executable instructions or program codes, program data and/or other appropriate forms of information. A program (20) stored in the computer readable storage medium (16) includes a set of executable instructions by the processor (14). In one example, the computer readable storage medium (16) may be a memory (volatile memory such as random access memory, non-volatile memory, or a suitable combination thereof), at least one magnetic disk storage device, optical disk storage devices, flash memory devices, other forms of storage media which can be accessed by other computing device (12) and store desired information, or a suitable combination thereof.

The communication bus (18) interconnects various other components of the computing device (12) by including the processor (14) and computer readable storage medium (16).

The computing device (120) may also include at least one input/output interface (22) and at least one network communication interface (26) which provide interfaces for at least one input/output device (24). The input/output interface (22) and network communication interface (26) are connected to the communication bus (18). The input/output device (24) may be connected to other component of the computing device (12) through the input/output interface (22). The exemplary input/output device (24) may include a pointing device (mouse or trackpad, etc.), a keyboard, a touch input device (touchpad or touchscreen, etc.), a voice and sound input device, various kinds of input devices such as sensor devices and/or photographing devices, and/or an output device such as a display device, a printer, a speaker, and/or a network card. An exemplary input/output device (24) may be included inside the computing device (12) as one component consisting of the computing device (12), and may be connected with the computing device (12) with a separate device distinguished from the computing device (12).

According to the disclosed examples, a deep-learning-based document classification device which is lightened while maintaining accuracy of document classification, by pruning tokens based on fuzzy theory, and generating combined tokens based on similarity, and a document classification method for performing the same can be provided.

Representative examples of the present invention are described in detail above, but those skilled in the art to which the present invention pertains will understand that various modifications can be made to the afore-mentioned examples within limits without departing from the scope of the present invention. Therefore, the scope of the present invention should not be limited to the examples described, and should be determined by not only claims described later but also equivalents to these claims.

What is claimed is:

1. A document classification method performed in a computing device equipped with one or more processors and a memory storing one or more programs executed by the one or more processors, the document classification method comprising:
acquiring sequence data obtained by digitizing a document, and embedding the acquired sequence data to produce embedded data including one or more tokens;
generating fuzzy-pruned data pruned by performing token pruning the embedded data, which is a set of tokens, based on fuzzy theory;
producing combined tokens by combining tokens of the pruned fuzzy-pruned data with seed tokens of seed data, and generating combined data as a set of the combined tokens; and
producing one classification value based on the combined data.

2. The document classification method according to claim 1, wherein the generating of the fuzzy-pruned data comprises:
calculating a token importance score being an indicator of a degree of importance for each token comprised in the embedded data; and
performing the pruning based on the token importance score.

3. The document classification method according to claim 2, wherein the performing of the pruning based on the token importance score comprises:
calculating an importance index and an unimportance index being a criterion of the pruning by applying the fuzzy theory to the token importance score, for each of the tokens of the embedded data; and
performing the pruning the tokens of the embedded data according to a predetermined criterion based on the importance index and the unimportance index.

4. The document classification method according to claim 3, wherein the importance index (Importance(S)) is calculated by Equation 1:
$$Importance ( S ) = \{ \begin{matrix}0 & if S ( e ) \leq a \\ \frac{S ( e ) - a}{b - a} & if a < S ( e ) < b \\ 1 & if S ( e ) \geq b\end{matrix} \qquad [ Equation 1 ]$$
wherein Importance(S) is the importance index,
S(e) is the token importance score,
a is a predetermined lower limit of the token importance score, and
b is a predetermined upper limit of the token importance score.

5. The document classification method according to claim 3, wherein the unimportance index (Unimportance(S)) is calculated by Equation 2:
$$Unimportance ( S ) = \{ \begin{matrix}1 & if S ( e ) \leq a \\ \frac{b - S ( e )}{b - a} & if a < S ( e ) < b \\ 0 & if S ( e ) \geq b\end{matrix} \qquad [ Equation 2 ]$$
wherein Unimportance(S) is the unimportance index,
S(e) is the token importance score,
a is a predetermined lower limit of importance score, and
b is a predetermined upper limit of importance score.

6. The document classification method according to claim 2, wherein the performing of the pruning comprises removing the tokens of the embedded data from computation targets of a fuzzy pruning attention neural network.

7. The document classification method according to claim 6, wherein the removing the tokens of the embedded data from the computation targets of the fuzzy pruning attention neural network comprises removing at least one of a key vector and a value vector of each token of the embedded data.

8. The document classification method according to claim 1, wherein the generating of the combined data comprises:
calculating similarity between each token of the fuzzy-pruned data and each seed token;
generating seed determination data indicating to which seed token each token of the fuzzy-pruned data is to be combined, according to the similarity; and
combining the tokens of the fuzzy-pruned data with the seed tokens of the seed data, based on the seed determination data.

9. The document classification method according to claim 8, wherein the calculating of the similarity comprises performing cross attention between the fuzzy-pruned data and the seed data which is a set of the seed tokens to which each token of the fuzzy-pruned data is to be combined.

10. The document classification method according to claim 8, wherein the generating of the seed determination data comprises determining that each token of the fuzzy-pruned data is to be combined with a seed token with the highest similarity among a plurality of the seed tokens.

11. A document classification device equipped with one or more processors and a memory storing one or more programs executed by the one or more processors, comprising:
an embedding module configured to acquire sequence data obtained by digitizing a document, and embeds the acquired sequence data to produce embedded data including one or more tokens;
a fuzzy pruning module configured to generate fuzzy-pruned data pruned by performing token pruning the embedded data, which is a set of tokens, based on fuzzy theory;
a combining module configured to produce combined tokens by combining tokens of the pruned fuzzy-pruned data with seed tokens of seed data, and generates combined data as a set of the combined tokens; and
a classification module configured to produce one classification value based on the combined data.

12. The document classification device according to claim 11, wherein the fuzzy pruning module is configured to:
calculate a token importance score being an indicator of a degree of importance for each token comprised in the embedded data;
calculate an importance index and an unimportance index being a criterion of the pruning by applying the fuzzy theory to the token importance score, for each of the tokens of the embedded data; and
perform the pruning the tokens of the embedded data according to a predetermined criterion based on the importance index and the unimportance index.

13. The document classification device according to claim 11, wherein the combining module is configured to:
calculate similarity between each token of the fuzzy-pruned data and each seed token;
generate seed determination data indicating to which seed token each token of the fuzzy-pruned data is to be combined, according to the similarity; and
combine the tokens of the fuzzy-pruned data with the seed tokens of the seed data, based on the seed determination data.

14. The document classification device according to claim 13, wherein the combining module is configured to determine that each token of the fuzzy-pruned data is to be combined with a seed token with the highest similarity among a plurality of the seed tokens.

15. A computer program stored in a non-transitory computer readable storage medium, the computer program comprising:
one or more instructions, when executed by a computing device having one or more processors, to make the computing device,
perform acquiring sequence data obtained by digitizing a document, and embedding the acquired sequence data to produce embedded data including one or more tokens;
generating fuzzy-pruned data pruned by performing token pruning the embedded data, which is a set of tokens, based on fuzzy theory;
producing combined tokens by combining tokens of the pruned fuzzy-pruned data with seed tokens of seed data, and generating combined data as a set of the combined tokens; and
producing one classification value based on the combined data.
